(19) United States
(12) Patent Application Publication
(10) Pub. No.: US 2014/0114919 A1
(43) Pub. Date: Apr. 24, 2014

(54) SYSTEMS AND METHODS FOR PROVIDING SYNCHRONIZED MEDIA CONTENT

(71) Applicant: UNITED VIDEO PROPERTIES, INC., Santa Clara, CA (US)

(72) Inventor: Thomas Steven Woods, Arlington Heights, IL (US)

(73) Assignee: UNITED VIDEO PROPERTIES, INC., Santa Clara, CA (US)

(21) Appl. No.: 13/656,359

(22) Filed: Oct. 19, 2012

(51) Int. Cl. G06F 7/00; G06F 17/30

(52) U.S. Cl. 707/634; 707/E17.005

(57) ABSTRACT

Systems and methods for receiving and synchronizing a second version of a media asset with a first version of a media asset are provided. For example, a first version of a media asset may be a version from a content provider, such as a television network or other multimedia provider. A second version of a media asset may be a user-owned copy of the media asset. A processing device identifies the media asset, searches for a second version of the media asset, and identifies the content display point of the first version of the media asset. The processing device may present an option to access the second version of the media asset from the corresponding content display point.

### BACKGROUND

Modern day consumers have access to numerous entertainment options and a large amount of available media content. In many instances, users have access to the same content through multiple content sources. For example, multimedia providers, such as television broadcasts, may transmit movies and television shows, which the user owns or otherwise can freely access.

Content from a provider may include commercials, edited scenes, or other undesirable elements. Accordingly, a user may prefer to access his or her own copy of the media content. Traditional systems, however, fail to provide a fast and convenient way for users to access their own content based on content received from a content provider.

### SUMMARY

In view of the foregoing, systems and methods for synchronizing provider-based media content with content which a user owns or otherwise has access to are provided. For example, a user may want to avoid commercials included in a provider version of a media asset, or may prefer to watch an unedited version of the media asset. The user may additionally prefer to synchronize the media content so that the second version begins playing from the same point as the first version was playing when the switch was performed.

Accordingly, systems and methods for receiving and synchronizing a second version of a media asset with a first version of a media asset are provided. In certain aspects, a processing device receives a first version of a media asset over a network, identifies a first content display point of the first version of the media asset, and retrieves an identification data structure for the first version of the media asset. The processing device compares the identification data structure with a database of media assets to identify a second version of the media asset that is different from the first version and determines whether the user is authorized to access the second version of the media asset. In response to determining the user is authorized to access the second version of the media asset, the processing device presents to the user an option to access the second version of the media asset from a second content display point of the second version of the media asset corresponding to the first content display point.

In certain embodiments, the processing device receives a user request to access the second version of the media asset in response to presenting the option to access the second version of the media asset from a second content display point, accesses the second version of the media asset, and identifies the second content display point corresponding to the first content display point. In certain approaches, the processing device displays at a presentation device the second version of the media asset from the second content display point.

In certain embodiments, the processing device accesses the second version of the media asset from a remote media library. For example, the processing device may access a media server. In certain embodiments, the processing device accesses the second version of the media asset from a local media library. For example, the processing device may access a local disk or media storage.

In certain approaches, the processing device identifies the first content display point by retrieving at least one of a time counter, a frame counter, an image, a sound, and a chapter marker of the first version of the media asset. In certain approaches, the processing device identifies a second content display point by comparing the first content display point to at least one of a time counter, a frame counter, an image, a sound, and a chapter marker of the second version of the media asset. In certain approaches, the processing device compares the first content display point to the second version of the media asset in response to receiving a user request to access the second version of the media asset.

In certain embodiments, the first version of the media asset includes supplemental content associated with the media asset, and the second version of the media asset excludes the supplemental content. In certain approaches, the supplemental content is at least one of an advertisement, director cut, extended scene, shortened scene, closed captioning, website, replacement audio, and user review.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 illustrates an example of a cross-platform interactive media system in accordance with some embodiments of the present disclosure;

FIG. 5 shows an illustrative display screen for accessing a user media library in accordance with some embodiments of the present disclosure;

FIG. 6 shows an illustrative display screen for selecting to view a synchronized media asset from a user-accessible library in accordance with some embodiments of the present disclosure; and

FIG. 7 shows an illustrative flow diagram for delivering a synchronized media asset to a user in accordance with some embodiments of the present disclosure.

### DETAILED DESCRIPTION OF THE VARIOUS EMBODIMENTS

Systems and methods for receiving and synchronizing a second version of a media asset with a first version of a media asset are provided. In certain aspects, a processing device receives a first version of a media asset over a network, identifies a first content display point of the first version of the media asset, and retrieves an identification data structure for the first version of the media asset. The processing device compares the identification data structure with a database of media assets to identify a second version of the media asset that is different from the first version and determines whether the user is authorized to access the second version of the media asset. In response to determining the user is authorized to access the second version of the media asset, the processing device presents to the user an option to access the second version of the media asset from a second content display point of the second version of the media asset corresponding to the first content display point.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance. Content may be transmitted from content providers as described in further detail in relation to FIG. 4.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critics' ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

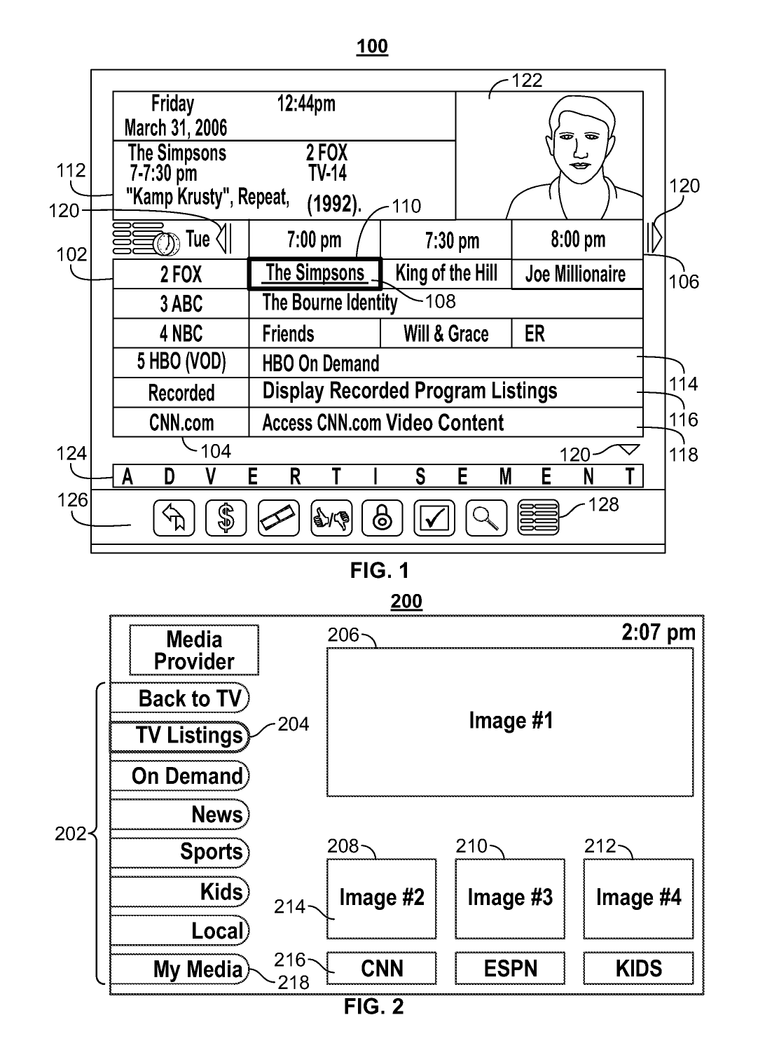

FIGS. 1-2 show illustrative display screens that may be used to provide media guidance data. The display screens shown in FIGS. 1-2 and 5-6 may be implemented on any suitable user equipment device or platform. While the displays of FIGS. 1-2 and 5-6 are illustrated as full screen displays, they may also be fully or partially overlaid over content being displayed. A user may indicate a desire to access content or content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content that is accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), cloud-based or remotely stored content, or other time-independent content. In certain approaches, the media content is associated with a user. For example, content may be stored on a network server, and be accessible to a particular user or group of users based on access permissions, such as paid or unpaid subscription-based services. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g., FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

In certain approaches, a user can access non-linear programming by moving highlight region 110 and selecting a program listing 108, which corresponds to scheduled linear content. Upon receiving a selection of program listing 108, a processing device, such as control circuitry 304 described in further detail below, may determine whether the user has access to a non-linear version of the media content. For example, the processing device may access a media library stored locally or remotely. If a non-linear version of the media asset is available, and the user is authorized to access the non-linear version of the media asset, the processing device may offer to display the non-linear version of the media asset. For example, a user may choose to access a non-linear version of the media asset to avoid commercials or have access to unedited scenes.

In certain approaches, the processing device initially synchronizes a non-linear version of the media asset with the linear version. For example, a processing device may begin transmitting the non-linear version from the same content point as the linear version is currently being transmitted. In this context, the terms “content point,” “content display point,” and “location” refer to a portion of a media asset displayed to or transmitted to the user. For example, a content point may be the part of a movie currently being displayed or the part of an audio file currently being played. Although transmission of media assets may be initially synchronized, in certain embodiments, the non-linear version of the media asset does not necessarily remain synchronized with the transmission schedule of the linear version of the media asset. For example, the linear version may have commercials, while the non-linear version has no commercials. Accordingly, the non-linear version may play continuously, while the linear version has commercial breaks. Additionally or alternatively, the non-linear version may be paused, stopped, or accessed from different content points preceding or succeeding the display point of the linear version of the media asset.

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to, or be unrelated to, one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

In certain approaches, library option 128 from options region 126 provides access to one or more media libraries, for which a user has authorization to access. For example, library option 128 may allow the user to access locally or remotely stored content. The library may include recorded content, purchased content, digitally rented content, subscription content, video-on-demand content, streaming content, or other non-linear content. In certain approaches, selecting library option 128 initiates a search for non-linear versions of scheduled linear content. In certain approaches, selecting library option 128 synchronizes the initial display of a non-linear version of a media asset with a scheduled linear version of a media asset so that the non-linear version begins playing from the same point as the linear version.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

In certain embodiments, selectable options 202 include a My Media option 218. Accessing option 218 may function similarly to library option 128 described in relation to FIG. 1 to provide access to one or more media libraries, which a user is authorized to access. For example, option 218 may allow the user to access locally or remotely stored content. The library may include recorded content, purchased content, digitally rented content, subscription content, video-on-demand content, streaming content, or other non-linear content.

In certain approaches, selecting My Media option 218 initiates a search for non-linear versions of scheduled linear content, such as those displayed in listings 206, 208, 210, and 212. Upon receiving a selection of option 218, a processing device, such as control circuitry 304 described in further detail below, may determine whether the user has access to a non-linear version of the media content from a remotely or locally stored media library of digital content. If a non-linear version of the media asset is available, and the user is authorized to access the non-linear version of the media asset, the processing device may offer to display the non-linear version of the media asset. In certain approaches, selecting option 218 synchronizes the initial display of a non-linear version of a media asset with a scheduled linear version of a media asset so that the non-linear version begins playing from the same point as the linear version. Additionally or alternatively, the non-linear version may be paused, stopped, or accessed from different content points preceding or succeeding the display point of the linear version of the media asset.

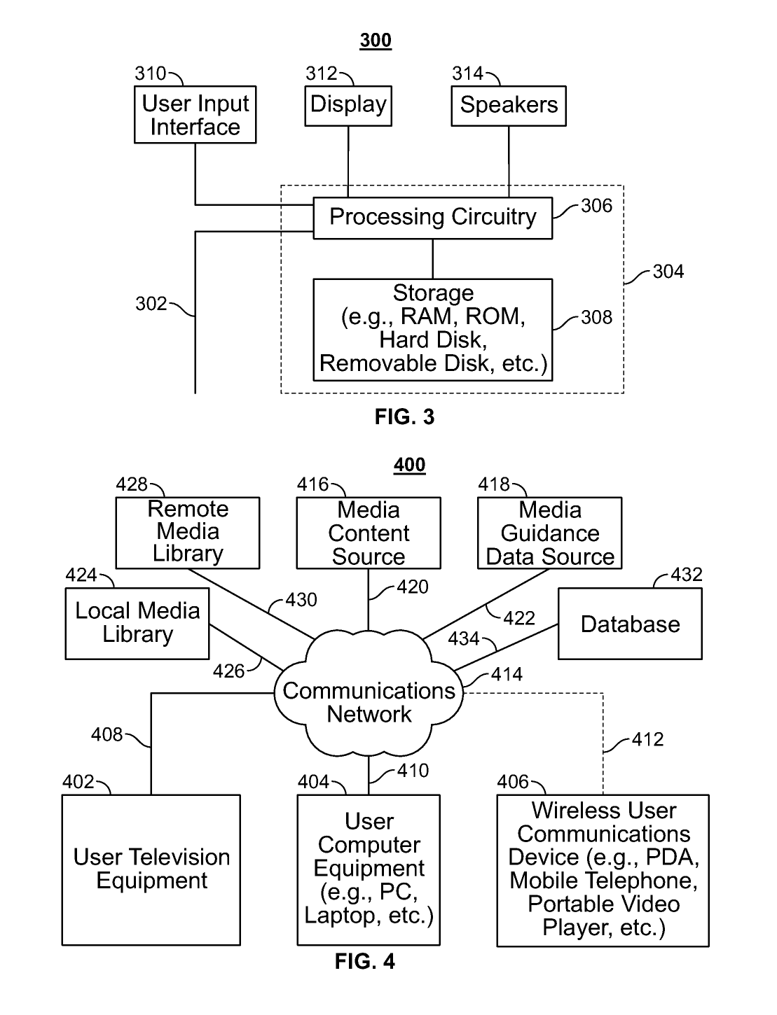

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 and, specifically processing circuitry 306, to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or a supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or may be used instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device, but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that, in the exemplary embodiment shown in FIG. 4, it is a wireless path, and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. In certain approaches, system 400 includes one or more media libraries and databases, such as local media library 424, remote medial library 428, and media database 432 coupled to communications network via communication paths 426, 430, and 434, respectively. Paths 420, 422, 426, 430, and 434 may include any of the communication paths described above in connection with paths 408, 410, and 412. Communications with the content source 416, media guidance data source 418, local media library 424, remote medial library 428, and database 432 may be exchanged over one or more communications paths, but are shown as a single path in FIG. 4 to avoid overcomplicating the drawing. In addition, there may be more than one of each of content source 416, media guidance data source 418, local media library 424, remote medial library 428, and database 432 but only one of each is shown in FIG. 4 to avoid overcomplicating the drawing. (The different types of each of these sources are discussed below.) If desired, content source 416, media guidance data source 418, local media library 424, remote medial library 428, and database 432 may be integrated as one source device or a combination of source devices.

Although communications between sources 416 and 418, libraries 424 and 428, and database 432 with user equipment devices 402, 404, and 406 are shown as through communications network 414, in some embodiments, sources 416 and 418, libraries 424 and 428, and database 432 may communicate directly with user equipment devices 402, 404, and 406 via communication paths (not shown) such as those described above in connection with paths 408, 410, and 412. Additionally, although communications paths are not drawn between content source 416, media guidance data source 418, local media library 424, remote medial library 428, and database 432, these devices and systems may communicate directly with each other via communication paths, such as those described above in connection with paths 408, 410, 412, 420, 422, 426, 430, and 434, as well as other short-range point-to-point communication paths, such as USB cables, IEEE 1394 cables, wireless paths (e.g., Bluetooth, infrared, IEEE 802-11x, etc.), or other short-range communication via wired or wireless paths. These devices and systems may also communicate with each other directly through an indirect path via communications network 414.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

System 400 may additionally include local media library 424 and remote media library 428 to store and provide access to media content. Media libraries 424 and 428 may be independent from or a part of media content source 416. Media libraries 424 and 428 may include a media server used to store different types of content, including video content selected, stored, recorded, or purchased by a user. Local media library 424 may include locally stored content, such as content stored on any user equipment device described above or other storage device. Remote media library 428 may include cloud-based or other remotely stored content, or other time-independent content. In certain approaches, the media content is associated with a user or particular user device, such as user devices 402, 404, and 406. For example, content may be stored on a network server, and be accessible to a particular user or group of users based on access permissions, such as paid or unpaid subscription-based services.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels. In certain approaches, media database 432 is provided.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Media database 432 stores information related to media content available through, or provided from, media content source 416, local media library 424, and remote library 428. In certain approaches, media database 432 includes titles or other content-specific identification data structures related to content available at a user device from source 416 or libraries 424 and 428. Database 432 may be accessed by other components of system 400. For example, media guidance data source 418 may access database 432 to provide guidance data regarding availability of media assets.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418, one or more local media libraries 424, one or more remote media libraries 428, and one or more media databases 432. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

User equipment devices such as devices 402, 404, and 406, may provide content to a user from a media content source such as a television, cable, satellite, or internet provider. In certain approaches, a processing device provides this content linearly according to a predetermined schedule, as described above. For purposes of the present disclosure, this transmitted version of the media asset may be termed a “provider version” of a media asset. In certain approaches, the user may have access to the content through other media content sources, local media libraries, or remote media libraries. For example, a user may own a digital or physical copy of the media asset, or have access to a version of the media asset through alternative or additional media sources (e.g., NETFLIX). For purposes of the present disclosure, this user accessible version of the media asset may be termed a “user version” of a media asset. The user version of the media asset may be accessed from a service provider, such as NETFLIX or other service, but it is differentiated from the provider version in that the user has specific access rights to the user version, which may include, for example, non-liner or on-demand access. In certain approaches, the systems and methods described herein verify whether the user has access to or is authorized to access a second version of a media asset other than provider version of the media asset.

A user may prefer to watch an alternative or user version of the media asset rather than the provider version for various reasons. For example, the linearly scheduled provider version may include or exclude supplemental or modified content. Examples of supplemental content include, but are not limited to, an advertisement, director's cut, extended scene, additional scene, shortened scene, closed captioning, website, replacement audio, and user reviews. Accordingly, the user may prefer to watch the user version accessed through the user's own media library, for example, to avoid commercials.

In certain approaches, the systems and methods described herein synchronize the initial display point of the user version of the media asset with the same point at which the provider version was displayed. For example, the user may be viewing a scene of a movie. In response to receiving a user request for a non-linear version of the movie, the processing device may initiate playback of the user version of the media asset beginning from the same scene at the same point.

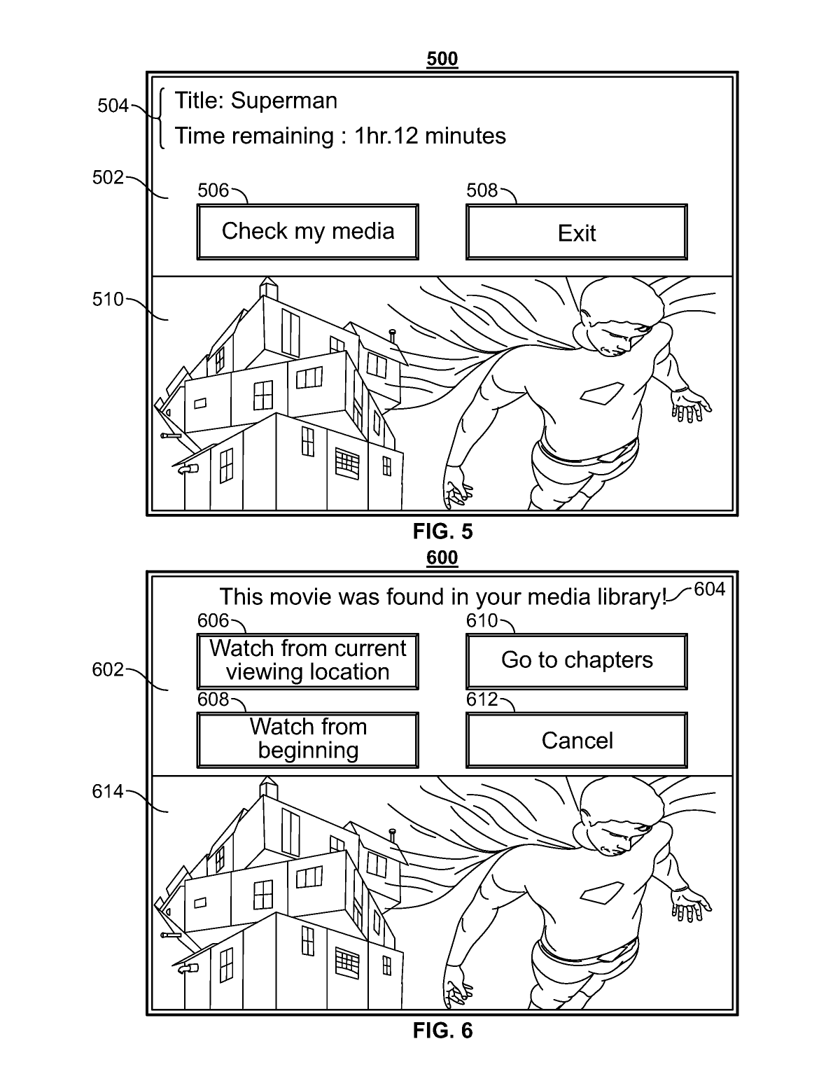

FIG. 5 shows an illustrative display screen for accessing a media asset from a user media library in accordance with some embodiments of the present disclosure. Display screen 500 depicts a scene 510 of a media asset, such as a movie. The media asset is provided as linear programming, which is transmitted on a predetermined schedule. In certain approaches, the media asset is a provider version of the media asset. Upon receiving the provider version of the media asset, a user may prefer to watch a user version of the media asset. Control circuitry 304 may receive a user selection from a user input interface, such as user input interface 310, indicating a request to access a non-provider or user version of the media asset. According, control circuitry 304 may, in response, generate and display window 502. In certain approaches, control circuitry 304 generates window 502 automatically in response to receiving a provider version of a media asset. Window 502 may include media asset information 504 such as the title, time remaining, summary, rating, or other information related to the provider version of the media asset displayed in screen 500.

In certain implementations, control circuitry 304 provides option 506 in window 502. Option 506 of FIG. 5 may include text, such as “Check my media” or “My Library.” However, any other appropriate instructions or icon may be used for option 506. Control circuitry 304 provides option 506 for checking whether the user is authorized to access a second, alternative, or user version of the media asset. For example, a user version of the media asset may be a non-linear version of the media asset accessible by control circuitry 304 through other media content sources, such as local media libraries or remote media libraries (e.g., local media library 424 or remote media library 428).

Control circuitry 304 may receive a user selection of option 508, and, in response, retrieve an identification data structure for the displayed media asset. In certain approaches, control circuitry 304 retrieves an identification data structure for the displayed media asset automatically in response to receiving the provider version of the media asset. Control circuitry 304 may retrieve an identification structure by accessing a database such as database 432 or other media guidance data to determine the title or other identification of the media asset. In certain approaches, control circuitry 304 of the user device accesses media guidance data source 418 to retrieve an identification data structure. Control circuitry 304 may then identify a second version of the media asset that is different from the displayed version by comparing the identification data structure with entries of a database, such as database 432, which includes identification data structures for media assets. In certain approaches, a second version of the media asset cannot be identified, for example, because a user does not have appropriate access permissions or because the second version does not exist. For example, the media asset may be a live presentation, or an episode of a television show, which has not been released for public sale or access.

In certain approaches, after identifying a second version media asset, control circuitry 304 may search within a database or library to find a second version of the media asset for transmitting to the user. In certain approaches, control circuitry searches for a second version of the media asset automatically in response to receiving the provider version of the media asset. Control circuitry 304 may search a database which lists available assets, and access a library holding the asset for transmitting. In certain approaches control circuitry 304 only searches within libraries, databases, and other content sources which the user is authorized to access. For example, control circuitry 304 may search within a database which identifies media assets which the user owns in a physical or digital copy. In certain approaches control circuitry 304 searches within databases, libraries, or sources which the user is authorized to access such as subscription-based services, public databases, or video-on-demand libraries. Control circuitry 304 may also search libraries, databases, and content sources which the user is not authorized to access. For example, control circuitry 304 may search a database of media assets which can be accessed by providing additional payment or by completing an offer, such as viewing an extended advertisement at the beginning of transmission.

In certain approaches, upon receiving a user selection of option 508, control circuitry 304 may identify the content display point, or currently transmitted portion, of the provider version of the media asset. Additionally or alternatively, control circuitry 304 may identify the content display point of the provider version of the media asset automatically in response to receiving the provider version of the media asset. Control circuitry 304 of the user device may identify the content display point of the provider version of the media asset by retrieving or calculating a time counter or frame counter of the media asset. In certain approaches, control circuitry 304 retrieves one or more images or audio samples of the media asset representing the specific display point or frame of the provider version of the media asset. In certain approaches, control circuitry 304 retrieves a time or chapter marker corresponding to the current content display point of the provider version of the media asset. In certain approaches, control circuitry 304 retrieves a combination of identifiers, including, but not limited to a time counter, frame counter, image, audio sample, and a chapter marker. In certain approaches, control circuitry 304 identifies the first content display point by accessing a media guidance data source, such as source 418.

In certain approaches, control circuitry 304 provides a “Cancel” or “Exit” option 508. Upon receiving a user selection of option 508, control circuitry 304 may close window 502 and continue to display the media asset as depicted in scene 510.

After identifying a second version of the media asset, control circuitry 304 provides the user with options to view the second version of the media asset. FIG. 6 depicts an illustrated display screen generated by control circuitry 304 for providing options to view the second version of the media asset. Screen 600 depicts a scene 614 of the media asset and also includes a window 602. Scene 614 may be similar to scene 510 of screen 500. Screen 600, and in particular, window 602, may be provided by control circuitry 304 in response to receiving the user selection of option 506 from FIG. 5, and identifying a second version (e.g., a non-linear or user version) of a media asset. In certain approaches, control circuitry 304 generates window 602 automatically after identifying a second version of a media asset.

Window 602 of screen 600 may include a region 604 for providing information or an instruction prompt. Region 604 indicates that a second version of the media asset displayed in screen 600 is available in a user accessible library. For example, region 604 includes the text “This movie was found in your media library!” Other messages or instructions may also be provided by control circuitry 304. Control circuitry 304 may also provide user options 606, 608, 610 and 612 within window 602. The function of these options is further described below.

Control circuitry 304 provides option 606 for watching a second version (e.g., a user version) of the media asset from the current display location of the provider version of the media asset. Option 606 of FIG. 6 may include text, such as “Watch from current viewing location.” However, any other appropriate instructions or icon may be used for option 606. Control circuitry 304 may receive a user selection of option 606, and in response, access or retrieve the second version of the media asset. For example, control circuitry 304 may access the second version of the media asset from a remote or local media library. In certain approaches, control circuitry 304 identifies a content display point within the second version of the media asset corresponding to the content display point of the provider version of the media asset. Control circuitry 304 may identify the corresponding content display point by searching for a corresponding time marker, frame, or chapter marker the second version of the media asset. In certain approaches, control circuitry 304 captures one or more images and/or audio sample from the first version of the media asset and performs an image and/or audio matching analysis with the second version of the media asset to identify the corresponding content display point.

In certain approaches, control circuitry 304 provides option 608 for watching a second version (e.g., a user version) of the media asset from the beginning. Option 608 of FIG. 6 may include text, such as “Watch from beginning.” However, any other appropriate instructions or icon may be used for option 608. Control circuitry 304 may receive a user selection of option 608, and, in response, access or retrieve the second version of the media asset. Control circuitry 304 may then display the second version of the media asset from the beginning.

In certain approaches, control circuitry 304 provides option 610 for watching a second version (e.g., a user version) of the media asset from chapter markers. Option 610 of FIG. 6 may include text, such as “Go to chapters.” However, any other appropriate instructions or icon may be used for option 610. In certain approaches, control circuitry 304 may receive a user selection of option 610, and, in response, display a menu with chapters for the second version of the media asset.

In certain approaches, control circuitry 304 provides a “Cancel” or “Exit” option 612. Upon receiving a user selection of option 612, control circuitry 304 may close window 602 and continue to display the media asset as depicted in scene 614.

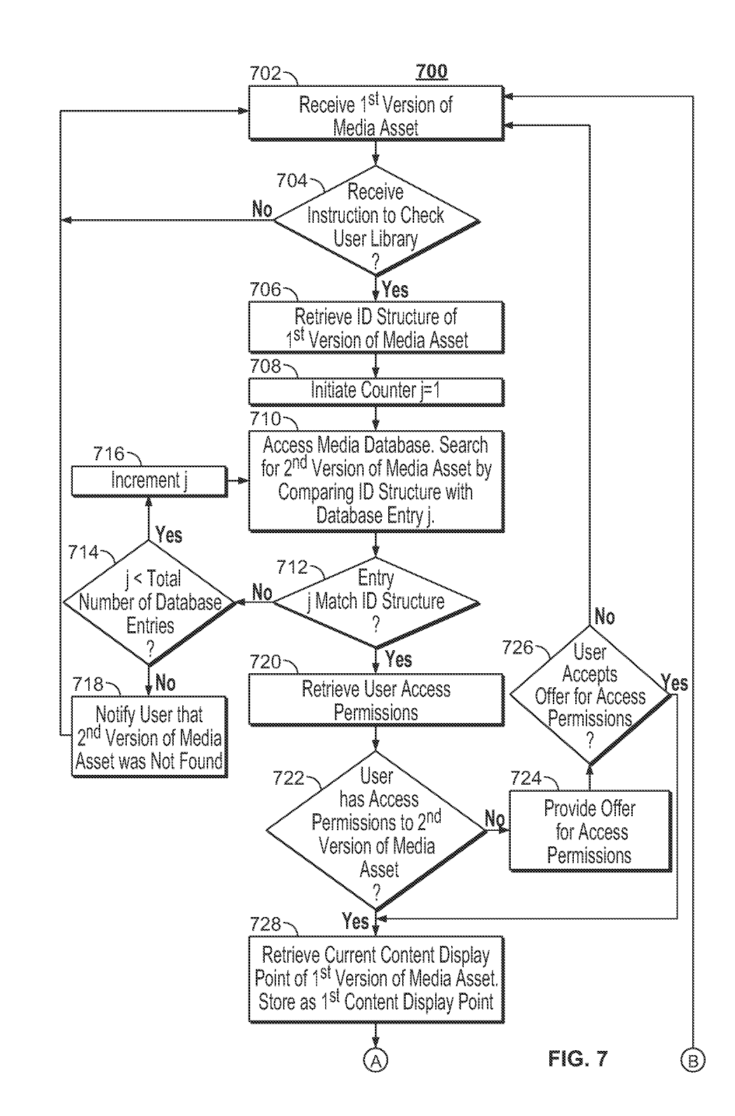

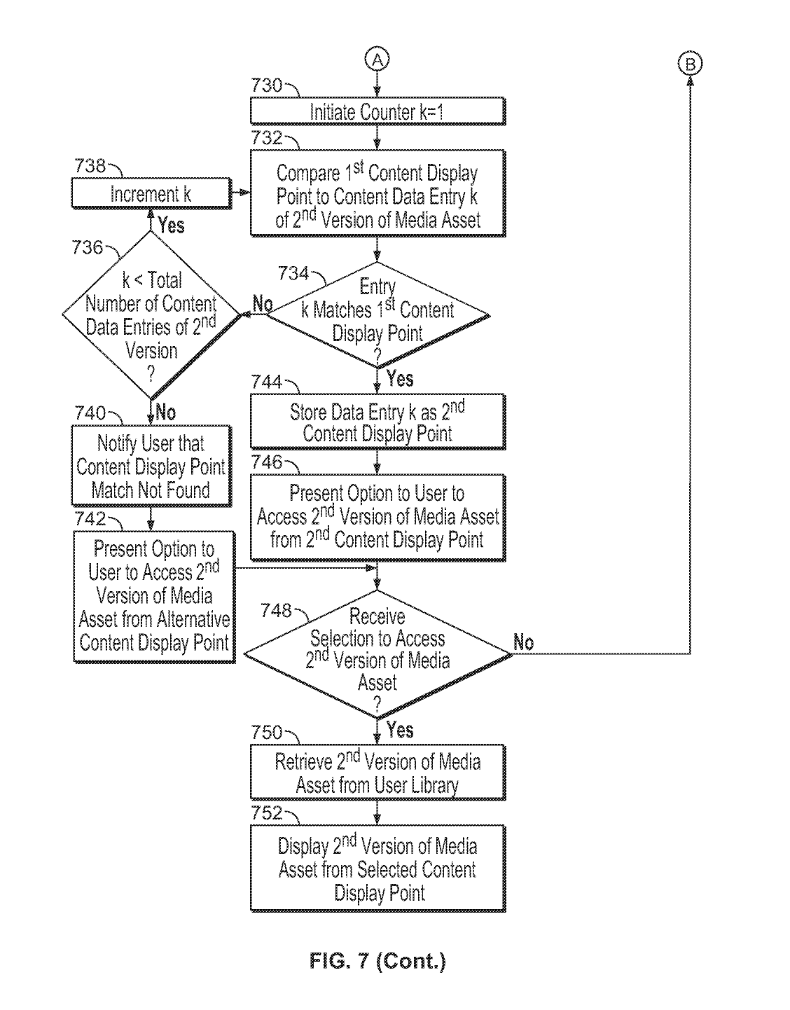

The flow diagram of FIG. 7 serves to illustrate some of the processes involved in some implementations of the systems and methods of the present disclosure. In particular, flow diagram 700 of FIG. 7 illustrates processes for delivering a second version of media asset to a user different from a first version of a media asset. For example, a first version of a media asset may be a provider version transmitted from a content provider on a predetermined schedule. A user may prefer to watch a user version of the media asset, such as a copy the user owns that does not have commercials. The steps of flow diagram 700 are performed by a processing device, such as control circuitry 304 of FIG. 3. The processing device may be part of a user device, such as user device 300 or user equipment 402, 404, or 406. Where appropriate, these processes may be implemented completely in the processing circuitry of a user equipment device, such as control circuitry 304 of FIG. 3, or may be implemented at least partially in a source remote from the user equipment devices.

At step 702, the processing device receives a first version of a media asset. In certain approaches the first version of the media asset is a provider version of a media asset, as described above, and received by a processing device from a service provider according to a pre-determined schedule. For example, the processing device may receive the first version of the media asset from a television broadcast, internet, or cable provider. In certain approaches, the first version of the media asset is modified by the media content provider. For example, the first version of the media asset may be edited for television with altered scenes or language. In certain approaches, the first version of the media asset is received by control circuitry 304 with commercials or other advertisements.

While the processing device is receiving a first version of the media asset, the processing device may receive instructions to check a user library for access to a second version of the media asset at step 704. The second version may be a user version of the media asset, as described above. In certain approaches, the processing device automatically checks a user library for a second version of the media asset. For example, the processing device may be programmed to automatically check a user library upon receiving a first version of a media asset from a content provider. In certain approaches, the processing device receives instructions to check a user library in response to user input. For example, the processing device may receive user input from a remote control or other user input interface, such as user input interface 310 of device 300. At step 704, if the processing device does not receive instructions to check a user library, the processing device continues to perform step 702 by receiving the first version of the media asset. If, at step 704, the processing device receives instructions to check a user library for a second version of the media asset, the processing device proceeds to perform step 706 and retrieves an identification structure of the first version of the media asset. The identification structure of the first version of the media asset is a unique identifier for the media asset, such as a title, identification number, symbol, or specifications. The processing device may retrieve the identification structure of the first version of the media asset from a media guidance data source such as data source 418. In certain approaches, the identification structure of the first version of the media asset is transmitted with the media asset.

After retrieving the identification structure, the processing device proceeds to search a media database. The processing device initiates a counter j at step 708 by setting the counter j to 1. The processing device uses counter j to track the search for a second version of the media asset within a media database. At process step 710, the processing device accesses a media database and performs a search for a second version of the media asset by comparing the identification structure from step 706 with database entry j. For example, if j=1, the processing device searches the first entry or “entry 1” of the database. The processing device progressively searches and compares each entry with the identification structure for the media asset until a match is found, or until all entries have been searched. For example, if entry j of the database does not match the identification structure at step 712, the processing device proceeds to step 714 to check whether the counter j is less than the total number of database entries. If counter j is less than the total number of database entries, the processing device increments counter j (e.g., increases the counter by 1) at step 716. The processing device then continues to search the database by performing step 710 again and comparing the identification structure with the next entry of the database. The processing device searches the database until either the identification structure of the media asset is found or until there are no longer database entries to search.

At step 714, if counter j is not less than the total number of database entries, the processing device proceeds to step 718 and notifies the user that a second version of the media asset was not found within the media database. The processing device then continues to perform step 702 by receiving the first version of the media asset.

At step 712, if the searched entry (entry j) matches the identification structure, the processing device proceeds to perform step 720 and retrieves user access permissions for the second version of the media asset. For example, user access permissions may be related to purchases from a user, digital rights management controls, or subscriptions to particular content provider services. At step 722, the processing device verifies whether the user access permissions permit the user to access the second version of the media asset. If, at step 722, the processing device determines from the access permissions that the user is authorized to access the second version of the media asset, the processing device will proceed to step 728.

In certain approaches, if processing device determines that the user is not authorized to access the second version of the media access, the processing device provides an offer for the user to receive access permissions at step 724. For example, the processing device may provide an offer for the user to purchase a copy of the second version of the media asset, purchase temporary access to the second version of the media asset (e.g., rent), subscribe to a service which provides access to the second version of the media asset, or view an advertisement. At step 726, if the processing device does not receive user input indicating acceptance of an offer for access permissions, the processing device proceeds to perform step 702 and continues to receive the first version of the media asset. If the processing device at step 726 receives input indicating the user accepts an offer to obtain access permissions for the second version of the media asset, the processing device proceeds to perform step 728.

At step 728, the processing device retrieves a current content display point of the first media asset. For example, the processing device may retrieve a marker, counter, or identifier indicative of a time or frame corresponding to the current content of the first version of the media asset being transmitted. In certain approaches, the processing device retrieves a current content display point by retrieving a frame image of the first version of the media asset. Additionally or alternatively, the processing device may retrieve a current content display point by retrieving audio sample of the first version of the media asset. In certain approaches, the processing device retrieves a chapter marker indicative of the current position being displayed for the first version of the media asset. In certain approaches, the processing device retrieves a first content display point which includes a combination of identifiers, including, but not limited to a time counter, frame counter, image, audio sample, and a chapter marker. The processing device stores the content display point as the first content display point. The processing device may store the first content display point in memory locally or remotely. For example, the processing device may store the first content display point in storage 308 of device 300.

After retrieving a first content display point for the first version of the media asset, the processing device proceeds to identify a corresponding content display point for the second version of the media asset. At step 730, the processing device initiates a new counter k by setting the counter k to 1. The processing device uses counter k to track the search for a corresponding content display point for the second version of the media asset.

At step 732, the processing device compares the first content display point to content data of the second version of the media asset. The content data may include multiple entries, such as frames, time markers, chapter markers, images, or audio. The processing device searches the content data of the second version of the media asset by comparing the first content display point to the content data entry k. For example, if k=1, the processing devices compares the first content display point with the first entry or “entry 1” of the content data. The processing device progressively searches and compares each entry with the first content display point until a match is found, or until all entries have been searched. For example, if the processing device does not find a match at entry k of the content data at step 734, the processing device performs step 736 and compares the value of counter k to the total number of content data entries to determine whether or not all content data entries have been searched. If counter k is less than the total number of content data entries, the processing device increments counter k (e.g., increases the counter by 1) at step 738 and proceeds to perform step 732 again by comparing the first content display point with the next content data entry k of the second version of the media asset.

In certain approaches, the processing device performs an image and audio matching analysis with the second version of the media asset to identify the corresponding content display point for the second version of the media asset. For example, the first content display point may include one or more images or audio samples from a scene of the first media asset, which was displayed to a user. The processing device may use pattern recognition algorithms to compare the first content display point to the audio or image content of each frame of the second version of the media asset. For example, the processing device may use classification, clustering, regression pattern recognition algorithms, Bayesian classifiers, kernel estimation, neural networks, sum-of-squared difference, principal component analysis, Markov models, Kalman filters, Gaussian regression algorithms, ensemble learning techniques, or any other appropriate recognition algorithms or techniques. The processing device may perform noise reduction, color adjustment or enhancement, contrast adjustment or enhancement, or other adjustments to an image or audio sample to improve the matching analysis. The processing device may perform a feature extraction step, such as identifying edges, lines, shapes, and patterns in an image or identifying rhythms, notes, sounds, voices, frequencies, or patterns in an audio sample.

In certain approaches, the processing device determines a probability estimate or confidence interval for the likelihood of a content match. For example, the processing device may determine that there is a 90% match or probability that a corresponding second content display point has been identified in the second version of the media asset. In certain approaches, the processing device uses one or more of a time counter, frame counter, image, audio sample, and a chapter marker to determine a match or probability of a match.

At step 734, if the processing device finds a data entry in the second version of the media asset corresponding to the first content display point, the processing device proceeds from step 734 to step 744 and stores the data at entry k as the second content display point. The processing device may store the second content display point in memory, such as in storage 308 of device 300. At step 746, the processing device presents an option to the user to access the second version of the media asset from the second content of display point. For example, the processing device may provide a screen similar to screen 600, as previously described. The processing device may present other options as well, including but not limited to, displaying a media asset from the beginning or from a specific chapter. The processing device may then proceed to step 748.

If the processing device has searched the entire content data for the second version of the media asset without identifying a corresponding entry, the processing device proceeds from step 736 to step 740 and notifies the user that a content display point match was not found. The processing device may then perform step 742 and present an option to the user to access the second version of the media asset from an alternative content display point. For example, the processing device may present an option to access the second version of the media asset from the beginning or from a chapter of the second version of the media asset. The processing device may then proceed to step 748.

At process step 748, the processing device may receive a selection to access the second version of the media asset. The selection may be received after presenting an option to access the second version of the media asset at either step 746 or step 742. If no selection is received at step 748, the processing device continues to receive the first version of the media asset at step 702. If the processing device receives a selection to access the second version of the media asset at step 748, the processing device performs step 750 and retrieves the second version of the media asset from a user library. For example, the processing device may retrieve the media asset from a locally or remotely stored media library, such as remote media library 428 or local media library 424 of system 400. In certain approaches the processing device retrieves the second version of the media asset from a physical device such as a DVD or BLU-RAY disc.

After retrieving the second version of the media asset, the processing device proceeds to step 752 and displays the second version of the media asset from the selected content display point. For example, if the processing device received a user selection to access the second version of the media asset from the second content display point which corresponds to the first content display point, the processing device will begin displaying the second version of the media asset from the second content display point. The processing device, thereby provides initial synchronization of the second version of the media asset with the first version of the media asset. Although transmission of versions of the media asset may be initially synchronized, in certain embodiments, the second version of the media asset does not necessarily remain synchronized with a transmission schedule of the first version of the media asset. For example, the first version may have commercials, while the second version has no commercials. Accordingly, the second version may play continuously, while the first version has commercial breaks. Additionally or alternatively, the second version may be paused, stopped, or accessed from different content points preceding or succeeding the display point of the linear version of the media asset. If the processing device received a user selection for an alternative content display point, such as a selection to watch the second version of the media asset from the beginning or from a chapter, the processing device will display the second version of the media asset from the selected content display point.

It should be understood that the above steps of the flow diagram of FIG. 7 may be executed or performed in any order and are not limited to the illustrated order. Some of the above steps of the flow diagram of FIG. 7 may be executed or performed substantially simultaneously where appropriate, or in parallel, to reduce latency and processing times. In certain approaches, various steps described above may be combined, omitted, not implemented, or integrated in other systems.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It is to be understood that, while certain forms of the present disclosure have been illustrated and described herein, it is not to be limited to the specific forms or arrangement of parts described and shown. Those skilled in the art will know or be able to ascertain, using no more than routine experimentation, many equivalents to the embodiments and practices described herein. Accordingly, it will be understood that the invention is not to be limited to the embodiments disclosed herein, which are presented for purposes of illustration and not of limitation.

What is claimed is:

1. A method for delivering a media asset to a user, comprising:
receiving, with a processing device over a network, a first version of a media asset;
identifying, with the processing device, a first content display point of the first version of the media asset;
retrieving, with the processing device, an identification data structure for the first version of the media asset;
comparing, with the processing device, the identification data structure with a database of media assets to identify a second version of the media asset that is different from the first version;
determining, with the processing device, whether the user is authorized to access the second version of the media asset; and
in response to determining the user is authorized to access the second version of the media asset, presenting to the user an option to access the second version of the media asset from a second content display point of the second version of the media asset corresponding to the first content display point.

2. The method of claim 1, further comprising:
receiving, at the processing device, a user request to access the second version of the media asset in response to presenting the option;
accessing, with the processing device, the second version of the media asset; and
identifying, with the processing device, the second content display point corresponding to the first content display point.

3. The method of claim 1, further comprising displaying, with the processing device at a presentation device, the second version of the media asset from the second content display point.

4. The method of claim 1, further comprising accessing the second version of the media asset from a remote media library.

5. The method of claim 1, further comprising accessing the second version of the media asset from a local media library.

6. The method of claim 1, wherein identifying the first content display point comprises retrieving at least one of a time counter, a frame counter, an image, a sound, and a chapter marker of the first version of the media asset.

7. The method of claim 1, further comprising identifying the second content display point by comparing the first content display point to at least one of a time counter, a frame counter, an image, a sound, and a chapter marker of the second version of the media asset.

8. The method of claim 1, wherein the comparing is in response to receiving a user request to access the second version of the media asset.

9. The method of claim 1, wherein the first version of the media asset includes supplemental content associated with the media asset, and the second version of the media asset excludes the supplemental content.

10. The method of claim 9, wherein the supplemental content is at least one of an advertisement, director cut, extended scene, shortened scene, closed captioning, website, replacement audio, and user review.

11. A system for delivering a media asset to a user, the system comprising:
a processor configured to:
receive a first version of a media asset over a network;
identify a first content display point of the first version of the media asset;
retrieve an identification data structure for the first version of the media asset;
compare the identification data structure with a database of media assets to identify a second version of the media asset that is different from the first version;
determine whether the user is authorized to access the second version of the media asset; and
in response to determining the user is authorized to access the second version of the media asset, present to the user an option to access the second version of the media asset from a second content display point of the second version of the media asset corresponding to the first content display point.

12. The system of claim 11, wherein the processor is configured to:
receive a user request to access the second version of the media asset in response to presenting the option;
access the second version of the media asset; and
identify the second content display point corresponding to the first content display point.

13. The system of claim 11, wherein the processor is configured to display the second version of the media asset from the second content display point.

14. The system of claim 11, wherein the processor is configured to access the second version of the media asset from a remote media library.

15. The system of claim 11, wherein the processor is configured to access the second version of the media asset from a local media library.

16. The system of claim 11, wherein the processor is configured to identify the first content display point by retrieving at least one of a time counter, a frame counter, an image, a sound, and a chapter marker of the first version of the media asset.

17. The system of claim 11, wherein the processor is configured to identify the second content display point by comparing the first content display point to at least one of a time counter, a frame counter, an image, a sound, and a chapter marker of the second version of the media asset.

18. The system of claim 11, wherein the processor is configured to compare the identification structure in response to receiving a user request to access the second version of the media asset.

19. The system of claim 11, wherein the first version of the media asset includes supplemental content associated with the media asset, and the second version of the media asset excludes the supplemental content.

20. The system of claim 19, wherein the supplemental content is at least one of an advertisement, director cut, extended scene, shortened scene, closed captioning, website, replacement audio, and user review.

21-30. (canceled)
